(19) United States
(12) Patent Application Publication
(10) Pub. No.: US 2006/0082585 A1
(43) Pub. Date: Apr. 20, 2006

(54) Apparatus and method for transposing data

(76) Inventor: In-Jae Yeo, Kyunggi-do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/111,690

(22) Filed: Apr. 20, 2005

(30) Foreign Application Priority Data
Oct. 14, 2004 (KR) 2004-82230

(51) Int. Cl. G09G 5/39

(52) U.S. Cl. 345/531

(57) ABSTRACT

The present invention relates generally to a data processing apparatus and method for transposing horizontally input image data into vertically arranged data and providing the vertically arranged image data to a scanning apparatus that requires vertically arranged data. More particularly, the present invention relates to a data processing apparatus and method, which rearrange input image data in such a way as to access memory on a 4- or 8-byte-at-a-time basis and repeatedly perform a writing operation on the memory two, four or more times per line at the time of writing the image data, which are input on a 2-byte-at-a-time basis in a horizontal direction, and provide data arranged in a vertical direction in such a way as to access the memory and read rearranged data in a vertical direction at the time of reading the image data.

### BACKGROUND OF THE INVENTION

1. Field of the Invention

The present invention relates generally to a data processing apparatus and method for transposing horizontally input image data into vertically arranged data and providing the vertically arranged image data to a scanning apparatus that requires vertically arranged data. More particularly, the present invention relates to a data processing apparatus and method, which rearrange input image data in such a way as to access memory on a 4- or 8-byte-at-a-time basis and repeatedly perform a writing operation on the memory two, four or more times per line at the time of writing the image data, which are input on a 2-byte-at-a-time basis in a horizontal direction, and provide data arranged in a vertical direction in such a way as to access the memory and read rearranged data in a vertical direction at the time of reading the image data.

2. Description of the Related Art

A Spatial Optional Modulator (SOM) device is a device for outputting High Definition Television (HDTV)-level images. In the SOM device, 1080 pixels are vertically arranged, so that the SOM device is configured to display images by scanning the images in a horizontal direction.

As shown in FIG. 1a, in typical HDTV applications, input image data are arranged in a horizontal direction. As shown in FIG. 1b, the SOM device has 1080 micromirror devices arranged in a vertical direction, so that it is configured to display images while scanning the images in a horizontal direction.

The present invention relates to an apparatus and method that receive data that are horizontally arranged as shown in FIG. 1a, and provide a data array that is vertically arranged as shown in FIG. 1b.

In the case of the universal HDTV standard, each frame of image has a row length (K)=1920 pixels and a column length (L)=1080 pixels, and each of the pixels is usually composed of three bytes, the three bytes corresponding to Red, Green and Blue (RGB) signals, respectively.

The SOM device used for the image scanning of universal HDTV is a device for outputting HDTV-level images. The SOM device has 1080 micromirror cells arranged in a row, and is configured to display images by scanning the images in a horizontal direction. Accordingly, the SOM device requires 1080 data that are arranged in a vertical direction in order to scan one frame of image composed of 1920×1080 pixels.

FIG. 2a shows the structure of one frame of image data, which is composed of 1920×1080 pixels. The image data shown in FIG. 2a are input from the outside in a horizontal direction in the order (0,0), (0,1), (0,2), (0,3), . . . . However, since the SOM device requires 1080 data arranged in a vertical direction, the input image data must be transposed from a horizontal arrangement to a vertical arrangement, as shown in FIG. 2b.

FIG. 3 is a block diagram of an HDTV system that is implemented using a conventional SOM device. The system of FIG. 3 includes an SOM device 11, an SOM driver 12 for driving the SOM device 11, flash memory 13 for storing a reference table to correct the characteristics of the SOM device, memory 14 for storing image data, a galvanometer mirror scanner 15 for scattering images onto a screen, and an SOM controller 16 for converting the arrangement of rows and columns of image data, transferring the converted image data to the SOM driver 11, and controlling the galvanometer mirror scanner 15. In this case, the SOM controller 16 functions to transpose input image data.

In order to transpose data as described above, memory capable of storing at least one frame of image is required. For example, to store one frame of image data at HDTV-level resolution (1920×1080 pixels), 2×3 Mbytes is required. 2×3 Mbytes is too large to be stored in a typical IC, so that additional memory, such as external memory, is provided and the transposition of data is performed using the additional memory.

In connection with the above description, Japanese Unexamined Pat. Pub. No. 1993-207264 discloses an image memory device that can convert the arrangement of image data, which are read by a scanner, in a horizontal or vertical direction in apparatuses such as a facsimile. The above-described document discloses a configuration that converts the arrangement of data in such a way as to write data into a memory array in a column direction using a row data buffer and read data in a row direction using a column data buffer. However, the memory configuration disclosed in the document has limitations in that it cannot process moving pictures and cannot be applied to fields requiring high-speed data processing, such as an HDTV.

### SUMMARY OF THE INVENTION

Accordingly, the present invention has been made keeping in mind the above problems occurring in the prior art, and an object of the present invention is to provide an apparatus and method for transposing data, which can reduce the size of an internal buffer necessary for a memory controller to several tens of bytes or less.

In order to accomplish the above object, the present invention provides a method for transposing data, including the steps of (a) reading one frame of image data on a 2-byte-at-a-time basis, accessing memory capable of storing at least one frame of image on a 2M-byte-at-a-time basis, and storing the read 2-byte data in 2M bytes of the memory; (b) storing the image data in the memory by repeating the step (a) M times so that M sets of two pieces of data of M lines of data, which are part of the image data, can be stored in every 2M-byte memory block of the memory on a 2-pieces-of-data-at-a-time basis; (c) accessing the memory, and reading preceding bytes that are repeated stored M times; and (d) accessing the memory, and reading following bytes that are repeatedly stored M times.

Additionally, the present invention provides an apparatus for transposing data, including memory for storing at least one frame of image data; and a memory controller for storing or reading data to or from the memory; wherein the memory controller reads one frame of image data on a 2-byte-at-a-time basis, accesses memory on a 2M-byte-at-a-time basis, and stores the read 2-byte data in 2M bytes of the memory; stores the image data in the memory by repeating the storing of the 2-byte data M times so that M sets of two pieces of data of M lines of data, which are part of the image data, can be stored in every 2M-byte memory block of the memory on a 2-pieces-of-data-at-a-time basis; accesses the memory, and reads preceding bytes that are repeated stored M times; and accesses the memory, and reads following bytes that are repeatedly stored M times.

If it is assumed that one frame of image is composed of K×L bytes (row length: K types and column length: L bytes), the apparatus and method of the present invention provide data, which are arranged in K-byte rows and one column (K×1 bytes), to an SOM device.

### BRIEF DESCRIPTION OF THE DRAWINGS

The above and other objects, features and advantages of the present invention will be more clearly understood from the following detailed description taken in conjunction with the accompanying drawings, in which:

FIG. 1a is a view illustrating the sequence of an input video signal, and FIG. 1b is a view illustrating the scanning direction of an SOM device;

FIG. 2a shows the pixels of one frame of image data that are composed of 1920×1080 pixels, and FIG. 2b shows a transposing process;

FIG. 3 is a block diagram of an HDTV system that is implemented using a conventional SOM device;

FIG. 4 is a schematic block diagram of an apparatus for transposing data according to the present invention;

FIG. 5 shows one frame of image data that are input to the memory controller of the data transposing apparatus according to the present invention;

FIGS. 6a and 6b illustrate a method of writing data to memory;

FIG. 7 shows the structure of one frame of data that are written to the memory according to the present invention; and

FIGS. 8a and 8b illustrate a method of reading data written to the memory.

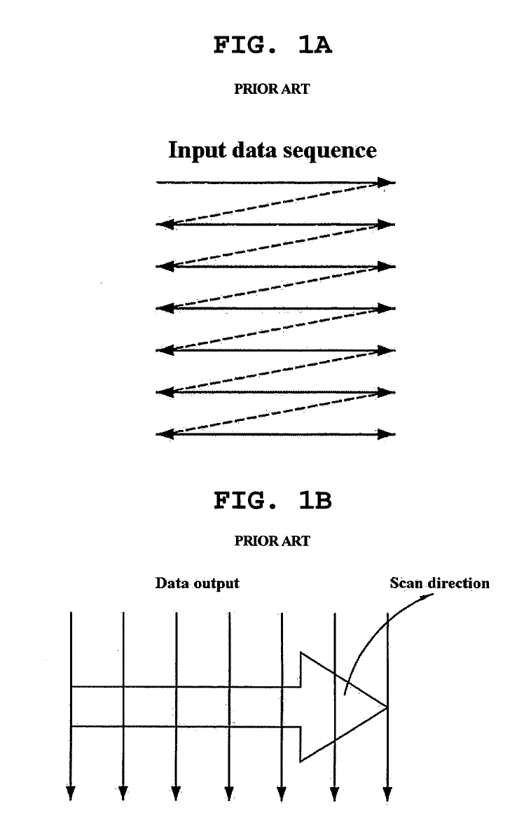

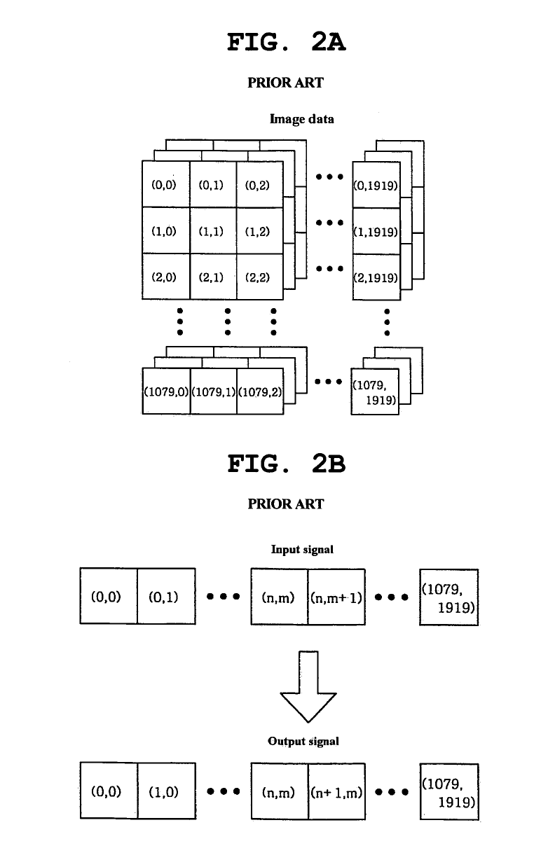

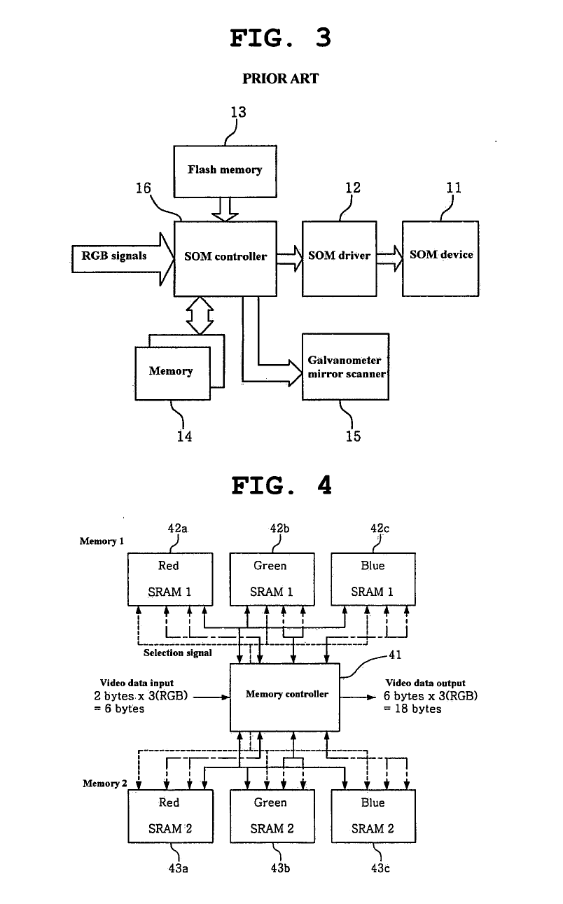

### DESCRIPTION OF THE PREFERRED EMBODIMENTS

Reference now should be made to the drawings, in which the same reference numerals are used throughout the different drawings to designate the same or similar components.

FIG. 4 is a schematic block diagram of an apparatus for transposing data according to the present invention. As shown in FIG. 4, image data are input to a memory controller 41 on a 6-byte-at-a-time basis, 2 bytes for each of the RGB signals. The memory controller 41 stores the input data alternately in memory 1 42a, 42b or 42c and in memory 2 43a, 43b or 43c for each of the RGB signals. Preferably, the memory is Static Read Access Memory (SRAM) or Synchronous SRAM (SBSRAM).

Thereafter, the memory controller 41 reads the image data stored in the memory 1 42a, 42b or 42c or the memory 2 43a, 43b or 43c in a transposing manner, and outputs the read image data. One of three pieces of memory 1 to store the image data is determined according to a selection signal. Furthermore, although FIG. 4 shows that data are output on an 18-byte-at-a-time basis, 6 bytes for each of the RGB signals, the basis may vary with a specific embodiment.

A process in which data are transposed as the memory controller 41 writes or reads data into or from the memory 1 42a, 42b or 42c or the memory 2 43a, 43b or 43c is described below. Since a processing method is the same for all the RGB signals, only a process in which the memory controller 41 writes or reads data to or from the memory 42a is described. The processing method that is described below is applied to all the RGB signals in the same manner.

FIG. 5 shows one frame of image data that are input to the memory controller 41. It is assumed that one frame of image is composed of n×m pixels (row length: n pixels, and column length: m pixels) and one pixel is 1 byte. As indicated by a dotted arrow in FIG. 5, data are input to the memory controller 41 on a 2-byte-at-a-time basis in the order [(0,0), (0,1)], [(0,2), (0,3)], . . . in a horizontal direction from the top to the bottom.

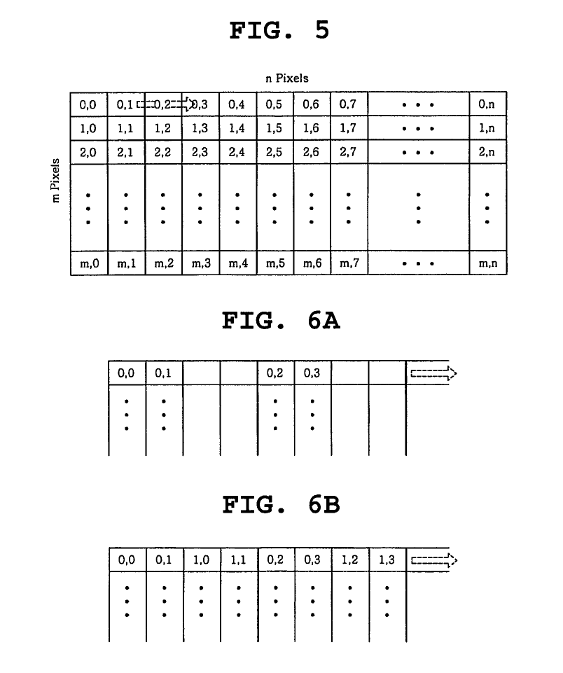

A method of writing data to the memory 42a is described with reference to FIGS. 6a and 6b.

As shown in FIG. 6a, the memory controller 41 accesses, for example, the memory 42a of FIG. 4 on a 4-byte-at-a-time basis, and writes 2-byte input data to the upper 2 bytes of the 4 bytes of each memory.

Thereafter, the memory controller 41 writes data, which exist in the second line of the image data of FIG. 5, to the lower 2 bytes of each of the accessed memory blocks. With the above-described operation, the image data in the first and second lines of FIG. 5 are stored in the 4-byte blocks of the memory 42a on a 2-byte-at-a-time basis, as shown in FIG. 6b.

However, the concepts of the upper 2 bytes and the lower 2 bytes are only illustrative, but data may be stored in 2 arbitrary bytes of every memory, not the upper 2 bytes of the memory. In this case, when a second write operation is performed on each memory, data are stored in locations other than the locations where the first 2 bytes are stored.

For ease of description, first 2 bytes and next 2 bytes from each memory line are called preceding bytes and following bytes, respectively. For example, in FIG. 6b, (0,0), (0,2), (0,4), . . . and (1,0), (1,2), (1,4), . . . in the first and second lines of input data are preceding bytes, and (0,1), (0,3), (0,5), . . . and (1,1), (1,3), (1,5), . . . are following bytes.

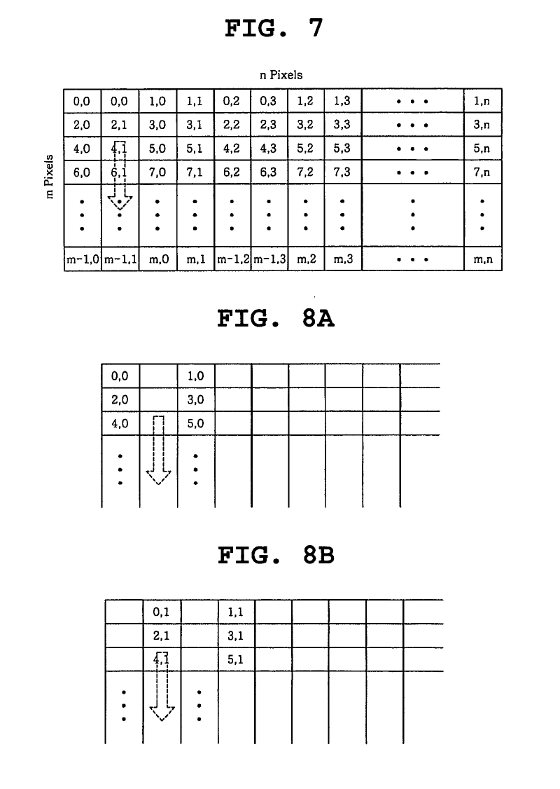

FIG. 7 shows the structure of one frame of data that is written to the memory 42a in the above-described manner.

Although, in the above embodiment, the memory controller 41 has been described as accessing the memory 42a on a 4-byte-at-a-time basis, the memory controller 41 can access the memory 42a on a 2M byte-at-a-time basis, such as an 8-byte-at-a-time basis or a 16-byte-at-a-time basis.

For example, in the case where the memory controller 41 access the memory 42a on a 2 Mb-at-a-time basis at the time of writing data to the memory 42a, one frame of image data is read on an M-byte-at-a-time basis, the memory 42a capable of storing at least one frame of image is accessed on a 2M-byte-at-a-time basis, and 2 input bytes are repeatedly stored in the 2M bytes of the memory so that M sets of 2-byte data from the M lines can be stored.

A process of reading data from the memory 42a is described with reference to FIG. 7 and FIGS. 8a and 8b. When data stored in the memory 42a are read, the data are read on a 4-byte-at-a-time basis in the direction indicated by the dotted arrow of FIG. 7. The preceding bytes of 4 bytes are read in a vertical direction, as shown in FIG. 8a, and the remaining following bytes are then read in a vertical direction, as shown in FIG. 8b.

Thereafter, for example, the preceding bytes read as shown in FIG. 8a, that is, (0,0), (1,0), (2,0), (3,0), (4,0), (5,0), . . . , are output, and the following bytes are then output. This process is repeated in a horizontal direction.

In this case, whenever data having a size corresponding to the size of the data input/output bus line of an external device, such as an SOM device, for receiving data from the memory controller 41, have accumulated, data are output. For example, if the size of the data bus line of the external device is 6 bytes, data are output whenever 6 bytes of data have accumulated, as shown in FIG. 4.

In the case where the memory controller 41 accesses the memory 42a on a 2M byte-at-a-time basis and writes data to the memory 42a, the memory is accessed and preceding bytes, which are repeatedly stored M times, are read therefrom, and the memory is accessed again and following bytes, which are repeatedly stored M times, are read therefrom. If a predetermined number of bytes have accumulated, for example, whenever 6 bytes are read, data are transferred to the external device.

Through the above-described process, data can be stored, with a write operation clock being completely synchronized with an input data clock, without the use of internal memory having large capacity in the memory controller 41. Several tens of bytes are sufficient for the size of the internal buffer required in the memory controller 41.

As described above, in accordance with the data transposing apparatus and method of the present invention, the size of the internal memory of the memory controller can be reduced to less than several tens of bytes.

Further, in accordance with the data transposing apparatus and method of the present invention, a write operation clock is synchronized with an input data clock, so that an additional Phase Locked Loop (PLL) or external high-speed clock device for clock division is not required within a memory controller during a write operation.

Furthermore, in accordance with the data transposing apparatus and method of the present invention, if the size of external memory is 4M or more bytes, the data transposing apparatus and method of the present invention can be applied to any display modes, such as VGA, UXGA, XGA, SXGA, HD1 and HD2.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for transposing data, comprising the steps of:
(a) reading one frame of image data on a 2-byte-at-a-time basis, accessing memory capable of storing at least one frame of image on a 2M-byte-at-a-time basis, and storing the read 2-byte data in 2M bytes of the memory;
(b) storing the image data in the memory by repeating the step (a) M times so that M sets of two pieces of data of M lines of data, which are part of the image data, can be stored in every 2M-byte memory block of the memory on a 2-pieces-of-data-at-a-time basis;
(c) accessing the memory, and reading preceding bytes that are repeated stored M times; and
(d) accessing the memory, and reading following bytes that are repeatedly stored M times.

2. The data transpose method as set forth in claim 1, wherein the step (b) comprises the step of storing the input image data in the 2M-byte memory block sequentially from an upper byte of the 2M-byte memory block.

3. The data transpose method as set forth in claim 2, wherein the step (c) comprises the step of reading odd-numbered bytes from the 2M-byte memory block.

4. The data transpose method as set forth in claim 2, wherein the step (d) comprises the step of reading even-numbered bytes from the 2M-byte memory block.

5. An apparatus for transposing data, comprising:
memory for storing at least one frame of image data; and
a memory controller for storing or reading data to or from the memory;
wherein the memory controller reads one frame of image data on a 2-byte-at-a-time basis, accesses memory on a 2M-byte-at-a-time basis, and stores the read 2-byte data in 2M bytes of the memory; stores the image data in the memory by repeating the storing of the 2-byte data M times so that M sets of two pieces of data of M lines of data, which are part of the image data, can be stored in every 2M-byte memory block of the memory on a 2-pieces-of-data-at-a-time basis; accesses the memory, and reads preceding bytes that are repeated stored M times; and accesses the memory, and reads following bytes that are repeatedly stored M times.
